(19) United States
(12) Patent Application Publication
(10) Pub. No.: US 2010/0263742 A1
(43) Pub. Date: Oct. 21, 2010

(54) Water Shutoff System

(76) Inventor: Margaret Bogdanska, San Marcos, CA (US)

Correspondence Address: SEAN KAUFHOLD, P. O. BOX 89626, SIOUX FALLS, SD, 57109, US

(21) Appl. No.: 12/427,527

(22) Filed: Apr. 21, 2009

(51) Int. Cl. E03B 7/07; F16K 37/00; F16K 31/06

(52) U.S. Cl. 137/389; 137/552.7

(57) ABSTRACT

A water shutoff system includes a water conduit having a passageway extending therethrough. The passageway includes an inlet in fluid communication with an outlet. Water enters the inlet and is released outwardly of the outlet. The inlet is couplable to a water supply and the outlet is couplable to a faucet. A valve is in fluid communication with the passageway. The valve is positionable in an open position allowing water flow through the passageway or in a closed position preventing water flow through the passageway. A drive mechanism is mechanically coupled to the valve. The drive mechanism is actuated to selectively alternate the valve between the open and closed positions. A control is operationally coupled to the drive mechanism to actuate the drive mechanism to open or close the passageway. The control actuates the drive assembly to close the passageway when a threshold limit has been achieved.

### BACKGROUND OF THE DISCLOSURE

### FIELD OF THE DISCLOSURE

The disclosure relates to water flow control devices and more particularly pertains to a new water flow control device for controlling the amount of water flow from a faucet, showerhead or the like.

### SUMMARY OF THE DISCLOSURE

An embodiment of the disclosure meets the needs presented above by generally comprising a water conduit that has a passageway extending therethrough. The passageway includes an inlet and an outlet in fluid communication with each other. Water entering the inlet is released by the conduit outwardly of the outlet. The inlet is couplable to a water supply and the outlet is couplable to a faucet. A valve is in fluid communication with the passageway. The valve is positionable in an open position allowing water flow through the passageway or in a closed position preventing water flow through the passageway. A drive mechanism is mechanically coupled to the valve. The drive mechanism is actuated to selectively alternate the valve between the open and closed positions. A control is operationally coupled to the drive mechanism to actuate the drive mechanism to open or close the passageway. The control actuates the drive assembly to close the passageway when a threshold limit has been achieved.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a front perspective view of a water shutoff system according to an embodiment of the disclosure.

FIG. 2 is a back perspective view of an embodiment of the disclosure.

FIG. 3 is a front view of an embodiment of the disclosure.

FIG. 4 is a cross-sectional view taken along line 4-4 of FIG. 3 of an embodiment of the disclosure.

FIG. 5 is a rear view of an embodiment of the disclosure.

FIG. 6 is a side view of an embodiment of the disclosure.

FIG. 7 is a side view of an embodiment of the disclosure.

FIG. 8 is a schematic view of an embodiment of the disclosure.

### DESCRIPTION OF THE PREFERRED EMBODIMENT

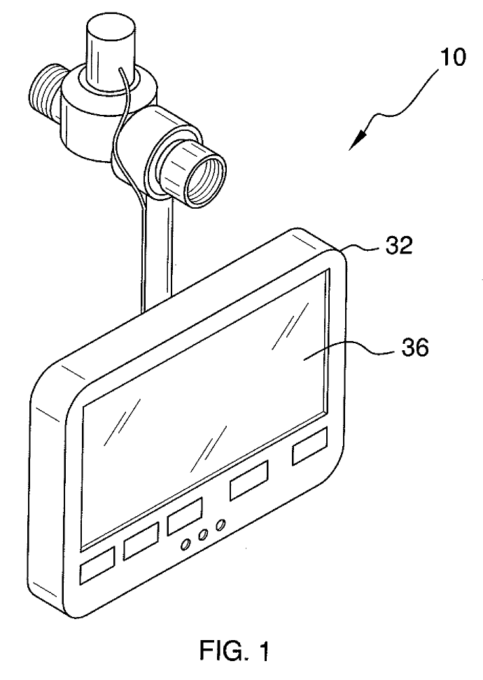

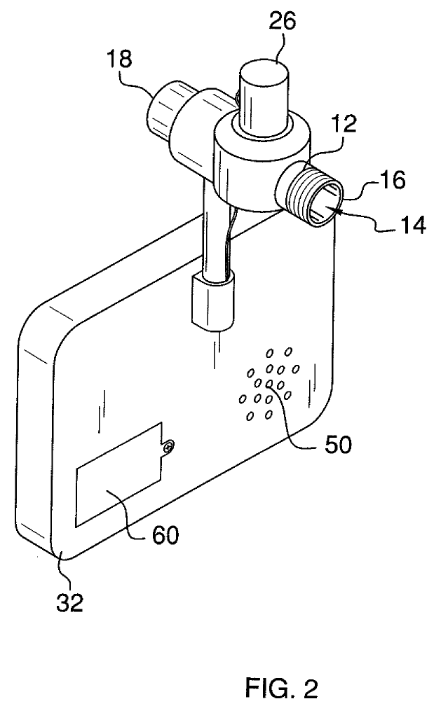

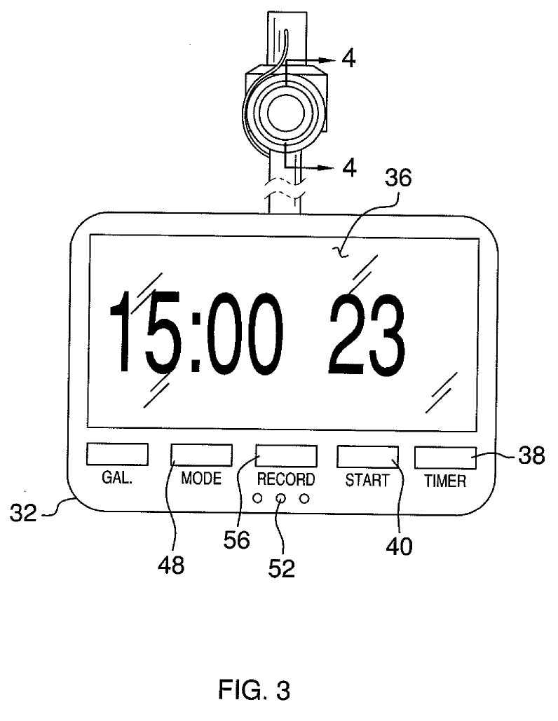

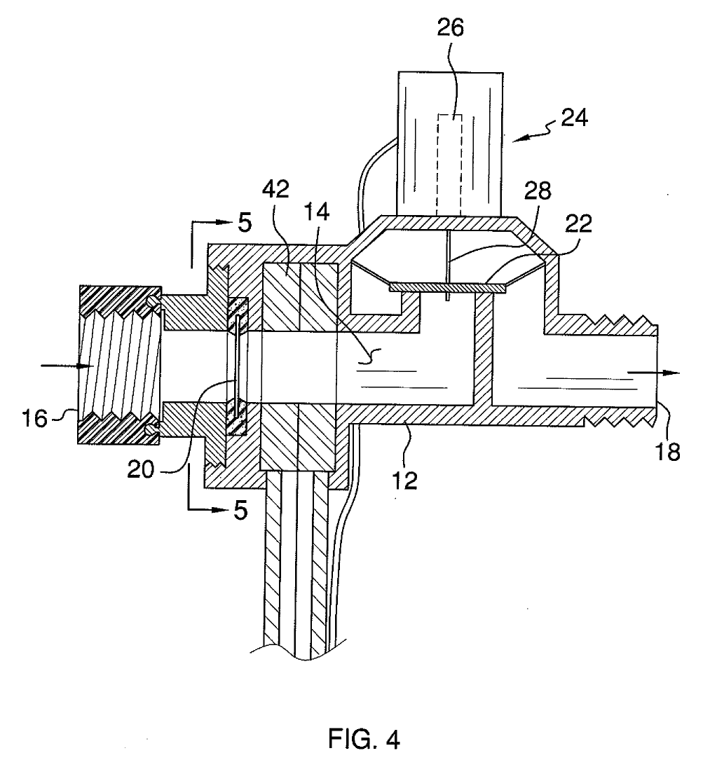

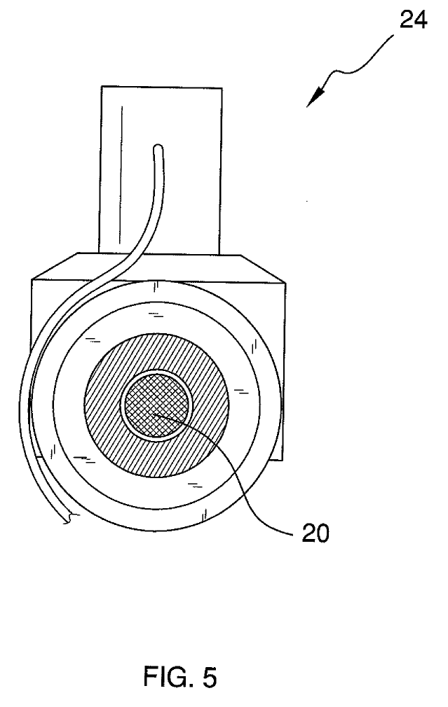

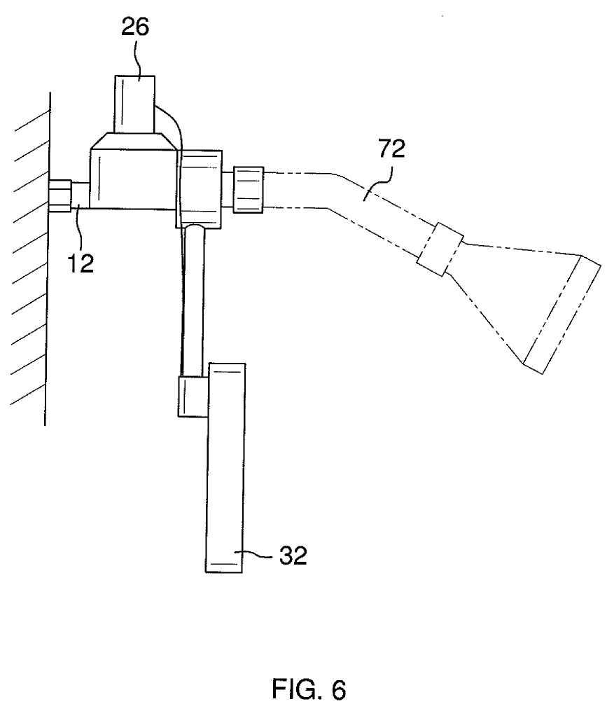

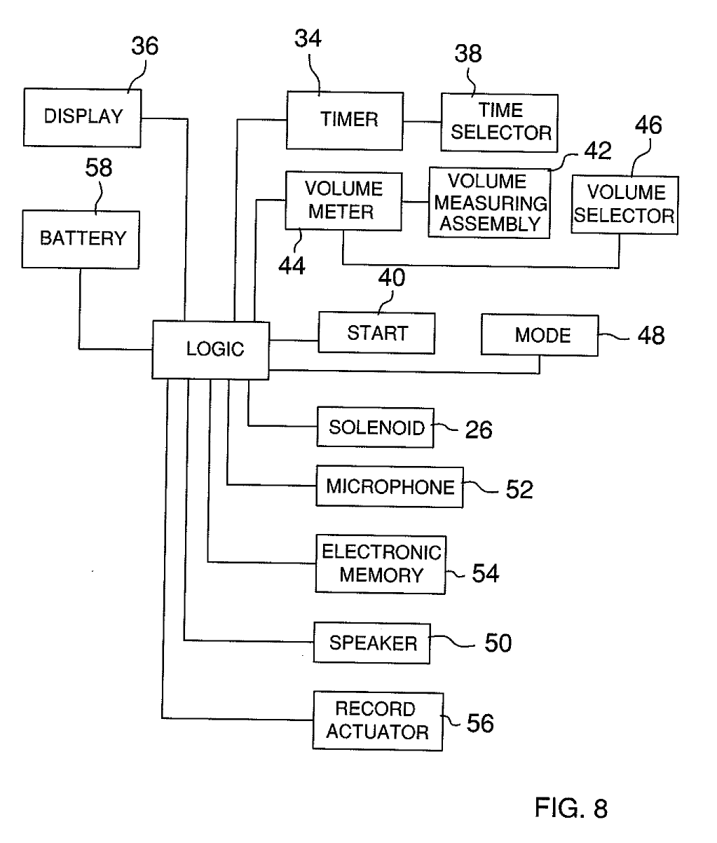

With reference now to the drawings, and in particular to FIGS. 1 through 8 thereof, a new water flow control device embodying the principles and concepts of an embodiment of the disclosure and generally designated by the reference numeral 10 will be described.

As best illustrated in FIGS. 1 through 8, the water shutoff system 10 generally comprises a water conduit 12 that has a passageway 14 extending therethrough. The passageway 14 includes an inlet 16 and an outlet 18 in fluid communication with each other. Water entering the inlet 16 is released by the conduit 12 outwardly of the outlet 18. The inlet 16 is couplable to a water supply 70 and the outlet 18 is couplable to a faucet 72. The faucet 72 may comprise a nozzle, spigot, showerhead, etc. which would be typically coupled to a water supply 70 though the system 10 is particularly well suited for showerhead attachments. The inlet 16 comprises a threaded female coupler and the outlet 18 comprises a threaded male coupler. A filtering screen 20 is positioned in the passageway to capture particulate in the water.

A valve 22 is in fluid communication with the passageway 14. The valve 22 is positionable in an open position allowing water flow through the passageway 14 or in a closed position preventing water flow through the passageway 14. A drive mechanism 24 is mechanically coupled to the valve 22. The drive mechanism 24 is actuated to selectively alternate the valve 22 between the open and closed positions. The drive mechanism 22 may comprise a solenoid 26 mounted to the conduit 12 and includes a drive shaft 28 coupled to the valve 22.

A control 30 is operationally coupled to the drive mechanism 24 to actuate the drive mechanism 24 to open or close the passageway 14. The control 30 actuates the drive assembly 24 to close the passageway 14 when a threshold limit has been achieved. The threshold limit is selected from the group consisting of a time limit and a volume limit.

The control 30 includes a housing 32 that is attached to the water conduit 12. The control 30 may include a timer 34 that is mounted within the housing 32 and is electrically coupled to the drive mechanism 24. The timer 34 is programmable to select a duration of time the valve 22 is positioned in the open position. The timer 34 actuates the drive mechanism 24 to move the valve 22 to the closed position when the duration of time has expired. A display 36 is electrically coupled to the timer 34 and displays the duration of time remaining. A time actuator 38 is operationally coupled to the timer 34 to selectively alter the duration of time. Maximum limits may be set as well as a second timing device which prevents resetting of the timer 34, and the valve 22 to the open position, for selected amount of time such as one minute. It should be understood that the valve 22 is retained in the closed position until the timer 34 is started, such as with a start actuator 40, at which point the drive mechanism 24 will move the valve 22 to the open position.

The control 30 also may include a volume measuring assembly 42 that is in fluid communication with the passageway 14 to measure an amount of water flowing through the passageway 14. This may include any conventional flow/volume measuring assembly such as an electromagnetic flow metering device. A volume meter 44 is mounted in the housing 32 and is operationally coupled to the volume measuring assembly 42 to track the volume of water flowing through the passageway 14. The volume meter 44 is operationally coupled to the drive mechanism 24. The volume meter 44 is programmable to select a maximum volume of water allowed to flow through the passageway 14. The volume meter 44 actuates the drive mechanism 24 to close the valve 22 when the maximum volume of water has been achieved. As with the timer 34, it should be understood that the drive mechanism 24 retains the valve 22 in the closed position until the volume meter 44 is started which may again be accomplished with the start actuator 40, though other means of starting and stopping the system 10 may be used. The volume meter 44 is electrically coupled to the display 36 to display a volume of water remaining. A volume actuator 46 is operationally coupled to the volume meter 44 to selectively alter the maximum volume of water.

A selection actuator 48 is operationally coupled to the timer 34 and the volume meter 44 to selectively choose actuation of the drive mechanism 24 by the timer 34 or the volume meter 44. This allows a person to determine for their self which is the most efficient means for controlling the usage and amount of water.

A speaker 50 is electrically coupled to the control 30 and emits an audible sound when at least 75% of the threshold limit has been achieved. The percentage may be altered but should be a percentage that provides ample warning that either only a percentage of time remains or only a percentage of water volume remains. The housing 32 may have the speaker 50 mounted therein as well as a microphone 52. The microphone 52 may be used to record the audible sound on electronic memory 54 that is electrically coupled to the speaker 50. A record actuator 56 may be mounted on the housing 32 and electrically coupled to the microphone 52 to turn on the microphone 52 and electronic memory 54 for recording phrases to be emitted when the threshold limit has been met.

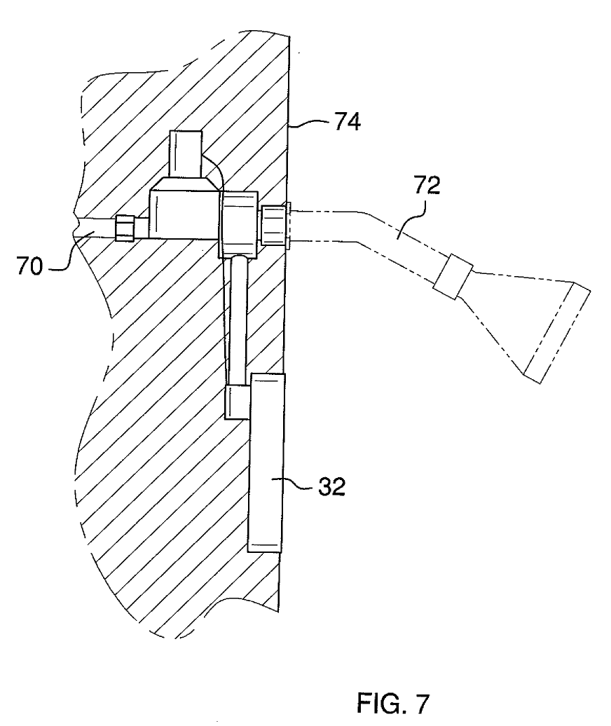

In use, the water conduit 12 is mounted to a water supply 70 and faucet 72 as described above and may be mounted within a wall 74 as shown in FIG. 7. The drive mechanism 24 and control 30 are powered by one or more batteries 58 removably mounted in the housing 32 and accessible by a door 60 in the housing 32. When a person wishes to shower, for instance, they set the control 30 to monitor either time or volume and start the control 30 so that the valve 22 is opened by the drive mechanism 24. When the threshold set by the user is attained, the drive mechanism 24 moves the valve 22 to the closed position to conserve water by preventing overly long showers.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure.

I claim:

1. A water shutoff system comprising:
a water conduit having a passageway extending therethrough, said passageway including an inlet and an outlet in fluid communication with each other, wherein water entering said inlet is released by said water conduit outwardly of said outlet, said inlet being couplable to a water supply, said outlet being couplable to a faucet;
a valve being in fluid communication with said passageway, said valve being positionable in an open position allowing water flow through said passageway or in a closed position preventing water flow through said passageway;
a drive mechanism being mechanically coupled to said valve, said drive mechanism being actuated to selectively alternate said valve between said open and closed positions; and
a control being operationally coupled to said drive mechanism to actuate said drive mechanism to open or close said passageway, said control actuating said drive assembly to close said passageway when a threshold limit has been achieved.

2. The system according to claim 1, wherein said inlet comprises a threaded female coupler and said outlet comprises a threaded male coupler.

3. The system according to claim 1, wherein said drive mechanism comprises a solenoid mounted to said water conduit and including a drive shaft coupled to said valve.

4. The system according to claim 1, wherein said threshold limit is selected from the group consisting of a time limit and a volume limit.

5. The system according to claim 1, wherein said control includes:
a housing being attached to said water conduit; and
a timer being mounted within said housing and being electrically coupled to said drive mechanism, said timer being programmable to select a duration of time said valve is positioned in said open position, said timer actuating said drive mechanism to move said valve to said closed position when said duration of time has expired.

6. The system according to claim 5, wherein said control further includes a display being electrically coupled to said timer and displaying said duration of time remaining.

7. The system according to claim 6, wherein said control further includes a time actuator being operationally coupled to said timer to selectively alter the duration of time.

8. The system according to claim 5, wherein said control further includes:
a volume measuring assembly being in fluid communication with said passageway to measure an amount of water flowing through said passageway;
a volume meter being mounted in said housing and being operationally coupled to said volume measuring assembly to track the volume of water, said volume meter being operationally coupled to said drive mechanism, said volume meter being programmable to select a maximum volume of water allowed to flow through said passageway, said volume meter actuating said drive mechanism to close said valve when said maximum volume of water has been achieved.

9. The system according to claim 8, wherein said control further includes a selection actuator being operationally coupled to said timer and said volume meter to selectively choose actuation of said drive mechanism by said timer or said volume meter.

10. The system according to claim 8, wherein said control further includes a display being electrically coupled to said timer and displaying said duration of time remaining, said volume meter being electrically coupled to said display to display a volume of water remaining.

11. The system according to claim 8, wherein said control further includes a volume actuator being operationally coupled to said volume meter to selectively alter the maximum volume of water.

12. The system according to claim 1, further including a speaker being electrically coupled to said control and emitting an audible sound when at least 75% of said threshold limit has been achieved.

13. The system according to claim 8, further including a speaker being electrically coupled to said control and emitting an audible sound when at least 75% of said threshold limit has been achieved.

14. The system according to claim 1, wherein said control includes:
a housing being attached to said water conduit;
a volume measuring assembly being in fluid communication with said passageway to measure an amount of water flowing through said passageway; and
a volume meter being mounted in said housing and being operationally coupled to said volume measuring assembly to track the volume of water, said volume meter being operationally coupled to said drive mechanism, said volume meter being programmable to select a maximum volume of water allowed to flow through said passageway, said volume meter actuating said drive mechanism to close said valve when said maximum volume of water has been achieved.

15. The system according to claim 14, wherein said control further includes a display being electrically coupled to said volume meter to display a volume of water remaining.

16. The system according to claim 14, wherein said control further includes a volume actuator being operationally coupled to said volume meter to selectively alter the maximum volume of water.

17. The system according to claim 14, further including a speaker being electrically coupled to said control and emitting an audible sound when at least 75% of said threshold limit has been achieved.

18. A water shutoff system comprising:
a water conduit having a passageway extending therethrough, said passageway including an inlet and an outlet in fluid communication with each other, wherein water entering said inlet is released by said water conduit outwardly of said outlet, said inlet being couplable to a water supply, said outlet being couplable to a faucet, said inlet comprising a threaded female coupler and said outlet comprising a threaded male coupler;
a valve being in fluid communication with said passageway, said valve being positionable in an open position allowing water flow through said passageway or in a closed position preventing water flow through said passageway;
a drive mechanism being mechanically coupled to said valve, said drive mechanism being actuated to selectively alternate said valve between said open and closed positions, said drive mechanism comprising a solenoid mounted to said water conduit and including a drive shaft coupled to said valve;
a control being operationally coupled to said drive mechanism to actuate said drive mechanism to open or close said passageway, said control actuating said drive assembly to close said passageway when a threshold limit has been achieved, said threshold limit being selected from the group consisting of a time limit and a volume limit, said control including;
a housing being attached to said water conduit;
a timer being mounted within said housing and being electrically coupled to said drive mechanism, said timer being programmable to select a duration of time said valve is positioned in said open position, said timer actuating said drive mechanism to move said valve to said closed position when said duration of time has expired;
a display being electrically coupled to said timer and displaying said duration of time remaining;
a time actuator being operationally coupled to said timer to selectively alter the duration of time;
a volume measuring assembly being in fluid communication with said passageway to measure an amount of water flowing through said passageway;
a volume meter being mounted in said housing and being operationally coupled to said volume measuring assembly to track the volume of water, said volume meter being operationally coupled to said drive mechanism, said volume meter being programmable to select a maximum volume of water allowed to flow through said passageway, said volume meter actuating said drive mechanism to close said valve when said maximum volume of water has been achieved;
said volume meter being electrically coupled to said display to display a volume of water remaining;
a volume actuator being operationally coupled to said volume meter to selectively alter the maximum volume of water;
a selection actuator being operationally coupled to said timer and said volume meter to selectively choose actuation of said drive mechanism by said timer or said volume meter; and
a speaker being electrically coupled to said control and emitting an audible sound when at least 75% of said threshold limit has been achieved.
